(19) United States
(12) Patent Application Publication
(10) Pub. No.: US 2020/0406270 A1
(43) Pub. Date: Dec. 31, 2020

(54) CENTRIFUGE ROTOR

(71) Applicant: Eppendorf AG, Hamburg (DE)

(72) Inventors: Steffen Kühnert, Leipzig (DE); Christoph Knospe, Hamburg (DE)

(73) Assignee: Eppendorf AG, Hamburg (DE)

(21) Appl. No.: 16/955,367

(22) PCT Filed: Dec. 17, 2018
(86) PCT No.: PCT/EP2018/085334

§ 371 Date: Jun. 18, 2020

(30) Foreign Application Priority Data
Dec. 20, 2017 (DE) 10 2017 130 786.9

(51) Int. Cl. B04B 5/04; B04B 7/02

(52) U.S. Cl. CPC B04B 5/0414; B04B 7/08; B04B 7/02

(57) ABSTRACT

A centrifuge rotor (10) has a closure (32) between a lower part (12) of the centrifuge rotor (10) and a cover (14). The closure has been improved such that proper single-handed operation is made possible. In particular, the closure (32) can be closed and detached again using just one hand. This means that the closure (32) has a simpler structure and can also be produced more cost-effectively.

### TECHNICAL FIELD

The present invention relates to a centrifuge rotor.

### BACKGROUND

Centrifuge rotors are used in centrifuges, in particular laboratory centrifuges, to separate the constituents of samples centrifuged therein using the inertia. In this process, ever greater rotational speeds are used to achieve high segregation rates. In this case, laboratory centrifuges are centrifuges of which the rotors operate at preferably at least 3,000, preferably at least 10,000, in particular at least 15,000 revolutions per minute and are usually placed on workbenches. In order to be able to place said centrifuges on a workbench, they in particular have a form factor of less than 1 m×1 m×1 m, i.e. its installation space is limited. Preferably, the appliance depth is limited to max. 70 cm here.

It is usually provided that the samples are centrifuged at certain temperatures. For example, samples that contain proteins and organic substances of this kind must not be overheated, and therefore the upper limit for the temperature control of such samples is in the range of +40° C. as standard. In addition, certain samples are cooled in the range of +4° C. as standard (the anomaly of the water begins at 3.98° C.).

In addition to such predetermined maximum temperatures of, for example, approx. +40° C. and standard analysis temperatures such as +4° C., further standard analysis temperatures are provided, such as +11° C., in order to test whether, at this temperature, the cooling system of the centrifuge runs in a regulated manner below room temperature. In addition, for reasons of occupational safety, it is necessary to prevent elements that have a temperature of greater than or equal to +60° C. from being touched.

As a rule, active and passive systems can be used for the temperature control. Active cooling systems have a coolant circuit which controls the temperature of the centrifuge bowl, as a result of which the centrifuge rotor and the sample container received therein are indirectly cooled.

Passive systems are based on exhaust-air-assisted cooling or ventilation. This air is guided directly past the centrifuge rotor, resulting in temperature control. In this process, the air is suctioned through openings in the centrifuge bowl, wherein the suctioning takes place independently due to the rotation of the centrifuge rotor.

The samples to be centrifuged are stored in sample containers and these sample containers are rotationally driven by means of the centrifuge rotor. In this process, the centrifuge rotors are usually set in rotation by means of a vertical drive shaft which is driven by an electric motor. There are various centrifuge rotors which can be used depending on the intended use. Here, the sample containers can contain the samples directly or separate sample receptacles which contain the sample are inserted in the sample containers such that a plurality of samples can be centrifuged at the same time in one sample container.

Broadly speaking, such centrifuge rotors usually comprise a lower part and a cover, wherein, when the cover is closed, an interior space is formed between the lower part and the cover, in which interior space the sample vessels can be arranged in order to centrifuge the samples in a suitable centrifuge. When the sample vessels are arranged at a fixed angle in the centrifuge rotor, this is what is known as a fixed angle rotor.

For connection to the centrifuge, the lower part is usually provided with a hub, which can be coupled to the drive shaft of the centrifuge, which is driven by the motor. The cover in turn is designed such that it can normally be closed against the lower part.

Usually, there is aerosol-tight sealing between the cover and the lower part, wherein, for example, the fixed angle rotor FA-45-48-11 from Eppendorf®, which can, for example, be used in the laboratory centrifuge 5430 R from Eppendorf®, comprises a discus-like cover in which a groove that is open radially outwards is arranged, wherein the groove contains an O-ring as a sealing means. When being closed, the cover is inserted into a corresponding, approximately vertically extending recess in the lower part and is braced downwards, wherein the O-ring is clamped between the groove and the side wall of the lower part in order to bring about the sealing. By means of the aerosol-tight sealing, the centrifuge containers can be easily transported and manipulated without the risk that the samples may contaminate the centrifuge or the surrounded portions.

The closure between the cover and the lower part may be configured in various ways.

First of all, centrifuge rotors are known in which a locking nut is arranged on the cover so as to be freely rotatable and the lower part comprises a corresponding thread surrounded portion the hub. An example of such a centrifuge rotor is the model F-45-32-5-PCR from Eppendorf®. In order to close the cover against the lower part, the cover has to be placed onto and screwed to the thread by means of the locking nut. This requires two hands, namely one hand that holds the lower part and one hand that places on and tightens the locking nut. In addition, the locking nut must complete several revolutions until the closure is secure, which is associated with increased effort.

In order to reduce this effort, centrifuge rotors are already known in which a kind of bayonet catch is used such that only approximately half a revolution of a corresponding locking nut needs to be completed until the closure is secure. An example of such a centrifuge rotor is the model FA-45-18-11 from Eppendorf®. In this case, the closure is in the form of a transmission thread, the pitch angle of which is selected such that the locking nut with its locking cam is automatically rotated until just before the closure position due to the dead weight of the cover. In addition, by means of a rubber-elastic seal, positive locking is provided, as described in EP 2 024 097 A1. As a result, the cover only needs to be placed on with one hand, after which the locking nut automatically rotates until before the locking position. The locking nut then still only needs to be rotated further by a few degrees in order to carry out the locking, wherein the rubber-elastic seal brings about the locking together with an indentation in the bayonet-catch slot opposite the locking cam. However, two hands are still required for this last step.

### SUMMARY

The object of the present invention is therefore to improve the centrifuge rotor in relation to the closure between the lower part of the centrifuge rotor and the cover such that a real single-handed operation is made possible. In particular, the closure is intended to be closed and detached again using just one hand. Preferably, the closure is intended to have a simpler structure and also to be produced more cost-effectively.

This object is achieved by the claimed centrifuge rotor according to claim 1. Advantageous developments are set out in the dependent claims and in the following description together with the drawings.

The inventor has identified that this problem can be solved particularly simply in a surprising manner if the closure is formed by a depression and a corresponding spring element. Here, the spring element can itself provide a spring effect or it may also be an element which is spring-mounted. By means of the spring effect, the closure can be easily closed and opened again.

The centrifuge rotor therefore comprises a lower part and a cover, wherein the centrifuge rotor has a rotational axis, wherein the cover can be placed onto the lower part along the rotational axis in a closing direction and can be removed along the rotational axis in a detaching direction, wherein, when the cover is closed, there is a closure between the lower part and the cover, and it is characterized in that at least one of the elements out of the lower part and the cover comprises at least one first depression, in which, when the cover is closed, at least one spring element engages, which is arranged on the other of the elements out of the cover and the lower part.

In an advantageous development, it is provided that the first depression and the spring element are adapted to provide a clip connection. Such a clip connection is a positive latching connection in which at least one latching element is designed to be resilient. As a result, the closure can be actuated particularly easily and without additional parts that actuate the spring element.

In an advantageous development, it is provided that the first depression is designed to open perpendicularly to the rotational axis. As a result, the closure is not exposed to any axial forces that cause it to become detached during the centrifuging, meaning that there are no moments that detach the closure, and this closure is particularly secure as a result. By shaping and/or positioning the first groove in a particular way, it can also be achieved that the cover is exposed to an emerging, closing axial force, by means of which said cover is pressed onto the lower part. For example, the groove could be asymmetrical, with the side wall being designed to be more vertical relative to the rotational axis in the detaching direction and the side wall being designed to be more inclined relative to the rotational axis in the closing direction. Alternatively, the groove may also be slightly offset in the detaching direction relative to the spring element, such that the spring element preloads the groove in the closing direction.

In an advantageous development, it is provided that the first depression is designed as a first annular groove. The closure can then be actuated for all the azimuthal orientations between the cover and the lower part, such that it fits very snugly.

In an advantageous development, it is provided that the first depression comprises a detaching aid, which is preferably designed as a first chamfer or rounded portion, by means of which the spring element is brought out of engagement with the first depression when the cover is removed from the lower part. As a result, when being detached, the closure can be actuated very easily and thus without excessive force.

In an advantageous development, it is provided that, in relation to the closing direction, a closing aid is arranged between the first depression and the lower part and is preferably designed as a second chamfer or rounded portion, by means of which the spring element is brought into engagement with the first depression when the cover is placed onto the lower part. As a result, when being closed, the closure can be actuated very easily and thus without excessive force.

In an advantageous development, it is provided that the first depression comprises a third chamfer or rounded portion in relation to the detaching direction on the side facing away from the lower part. As a result, the spring element is centered in the first depression during centrifuging, meaning that the closure is even better secured against the effect of axial forces.

In an advantageous development, it is provided that the first and/or the second and/or the third chamfer have an angle in the range of from 30° to 80°, preferably 45° to 75°, in particular 60°, relative to the rotational axis. Particularly good functioning is ensured at each of these angles. Instead of a chamfer, however, a rounded portion can also be used, wherein the rounded portion can be designed as a concave or convex rounded portion.

In an advantageous development, it is provided that the spring element is designed as an annular element, preferably as an annular spring, in particular as a diametric spring. This provides a closure that is particularly secure all the way around. Owing to the diametric spring, the closure is particularly easily accessible and secure at the same time. An O-ring could also be used as an annular element instead of a diametric spring.

In the context of the present disclosure, an annular element is understood to be an element extending around the rotational axis. Alternatively, spring elements could also be provided which only surround the rotational axis in portions, for example only at points. For example, coil springs or diametric springs could only be present in portions. Alternatively, there could be spring-loaded ball elements as spring elements. For example, resilient pressure pieces could be used.

In the context of the present disclosure, a diametric spring is understood to be a spring of which the winding is not parallel to the direction of the cross section of the spring, but is arranged so as to be inclined in a direction in a defined manner. In this case, the angle of inclination is in the range of from 20° to 70°, preferably 30° to 60°, more preferably 40° and 50°, and in particular 45°.

In an advantageous development, it is provided that the spring element is arranged in a second depression which is preferably designed as a second annular groove, wherein the second annular groove comprises lateral boundaries that in particular extend perpendicularly relative to the rotational axis. As a result, the spring element is retained particularly securely.

In an advantageous development, it is provided that the spring element has a cross section relative to its windings and, when the cover is open, at least a quarter, preferably half of this cross section is positioned in the second depression. As a result, the closure is very easily accessible, and the spring element is retained very securely.

In an advantageous development, it is provided that the cover and/or the lower part has an undercut which acts as a grip for supporting the centrifuge rotor, wherein the undercut preferably projects relative to the cover. As a result, the centrifuge rotor can be supported particularly easily and comfortably when the cover is closed.

In an advantageous development, it is provided that a part of the lower part reaches through the cover when closed and acts as a support aid for the centrifuge rotor, wherein this part is preferably a contrasting color from the cover. As a result, the support is very secure, because the cover cannot be involuntarily removed when the part of the lower part is gripped thereby.

In an advantageous development, it is provided that the part of the lower part is designed as at least two supporting grip elements that are arranged so as to be spaced apart and/or opposite one another relative to the rotational axis and preferably complement one another together with corresponding elements of the cover to form a continuous grip. The support can then be provided very comfortably.

Independent protection is claimed for this configuration in which a part of the lower part reaches through the cover when closed and acts as a support aid for the centrifuge rotor, wherein this part of the lower part is designed as at least two supporting grip elements that are arranged so as to be spaced apart and/or opposite one another relative to the rotational axis and preferably complement one another together with corresponding elements of the cover to form a continuous grip. This configuration can also be used for a centrifuge rotor which comprises a lower part and a cover, wherein the centrifuge rotor has a rotational axis, wherein the cover can be placed onto the lower part along the rotational axis in a closing direction and can be removed along the rotational axis in a detaching direction, wherein, when the cover is closed, there is a closure between the lower part and the cover, irrespective of whether at least one of the elements out of the lower part and the cover comprises at least one first depression, in which, when the cover is closed, at least one spring element engages, which is arranged on the other of the elements out of the cover and the lower part.

In an advantageous development, it is provided that the cover is designed without movable parts, preferably in one piece, in relation to the closure. As a result, the closure can be produced particularly simply and cost-effectively, because there is no rotatability of a locking nut relative to the cover. In another preferred configuration, in relation to the closure, the body of the centrifuge rotor consists only of an annular spring and a depression receiving said spring, i.e. of two parts, which likewise can be produced and maintained very simply and cost-effectively. Overall, the closure can thus consist of three parts: the annular spring, the depression which receives the annular spring, and the first depression which interacts with the annular spring in a closing manner.

In an advantageous development, it is provided that there is a preferably aerosol-tight seal between the cover and the lower part, such that the closure is arranged outside a sample space formed between the cover and the lower part in relation to the seal. As a result, the sample space is sealed particularly securely. This sealing could, for example, be arranged after the first depression in relation to the closing direction, wherein a sealing element is preferably used which is clamped between the cover and the lower part.

### BRIEF DESCRIPTION OF THE DRAWINGS

The features and further advantages of the present invention become apparent in the following with reference to the description of preferred embodiments in conjunction with the drawings, in which, purely schematically:

FIG. 1 is a perspective view of a centrifuge rotor according to a first preferred configuration,

FIG. 2 is a sectional view of the centrifuge rotor according to FIG. 1,

FIG. 3 is a sectional view of a detail of the region Z of the closure of the centrifuge rotor according to FIG. 2,

FIGS. 4a and 4b are a perspective view and a plan view, respectively, of the diametric spring used as part of the closure of the centrifuge rotor according to FIG. 1,

FIG. 5 is a perspective view of the centrifuge rotor according to a second preferred configuration,

FIG. 6 is a perspective view of the lower part of the centrifuge rotor according to FIG. 5, and

FIG. 7 is a perspective view of the cover of the centrifuge rotor according to FIG. 5.

### DETAILED DESCRIPTION

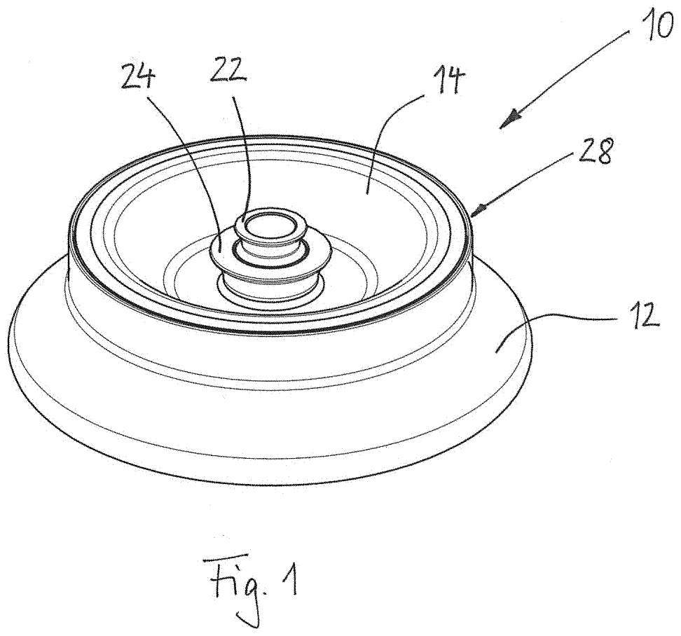

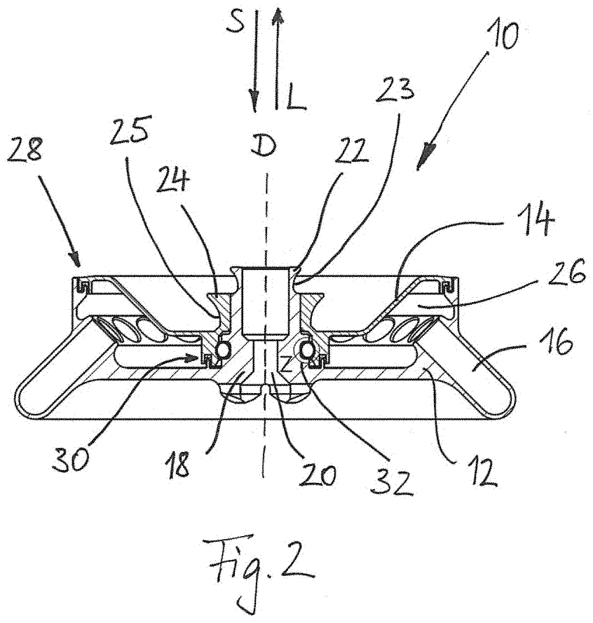

FIGS. 1 to 4 are various views of a first preferred configuration of the centrifuge rotor 10.

It is clear that this centrifuge rotor 10 is rotationally symmetrical and comprises a lower part 12 and a cover 14, wherein the cover 14 is placed onto the lower part 12 in a closing direction S that is parallel to the rotational axis D and can be removed in a detaching direction L that is parallel to the rotational axis D.

The lower part 12 comprises a series of evenly spaced holes or compartments 16 for receiving sample vessels in the form of test tubes, for example (not shown). A hub 18 comprising a hole 20 is arranged centrally in the lower part 12, which hole can receive a drive shaft of a laboratory centrifuge (neither are shown), by means of which the centrifuge rotor 10 can be driven. A supporting grip 22 comprising an undercut 23 provided for gripping is formed on the hub 18 so as to project from the cover 14, by means of which supporting grip the centrifuge rotor 10 can be gripped and supported without loosening the cover 14 as a result.

The cover 14 is formed in one piece and comprises an actuation grip 24 having an undercut 25 provided for gripping.

A sample space 26 is formed between the lower part 12 and the cover 14 and sealed in an aerosol-tight manner by the outer seal 28 and inner seal 30, which are arranged between the lower part 12 and the cover 14 and are each formed rotationally symmetrically relative to the rotational axis D. The compartments 16 and thus the individual sample vessels are accessible from this sample space 26.

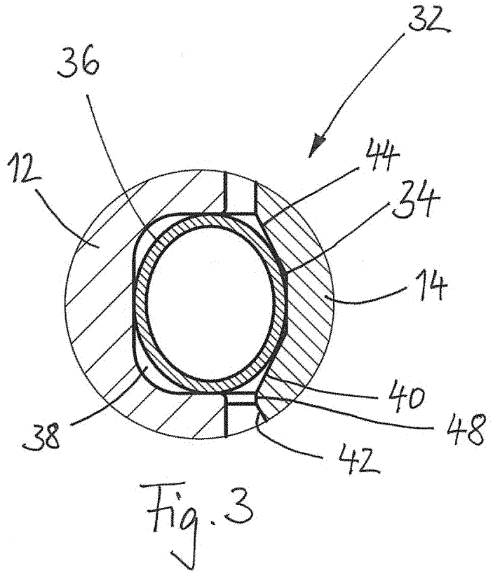

Furthermore, a closure 32 is formed between the lower part 12 and the cover 14, and is shown in a view of a detail in FIG. 3.

It is clear that the closure 32 is formed by three elements 34, 36, 38, namely a first depression 34 in the cover 14, the spring element 36, and the second depression 38, which retains the spring element 36.

The first depression 34, which is formed as an annular groove, is designed to open perpendicularly to the rotational axis D towards the rotational axis D and comprises a first chamfer 40, a second chamfer 42, and a third chamfer 44, wherein the chamfers 40, 42, 44 each have an angle of 30° relative to the rotational axis D. The depth of the first depression 34 relative to the inner circumferential surface of the actuation grip 24 is 1 mm. The height of the first depression 34 is configured in conjunction with the first chamfer 40 and the third chamfer 44 such that the spring element 36 is received in a compressed manner when the closure 32 is closed.

While there is a snug fit between the actuation grip 24 of the cover 14 and the hub 18 of the lower part 12, the cover 14 is arranged with radial spacing from the lower part 12 in the region of the closure 32, wherein the spacing is 1 mm.

The second depression 38 has an approximately rectangular cross section, wherein the corners are rounded due to the production process. The depth of the second depression 38 relative to the outer circumferential surface of the hub 18 is 3 mm. The height of the second depression 38 is configured such that the spring element 36 is received in a compressed manner when the closure 32 is closed.

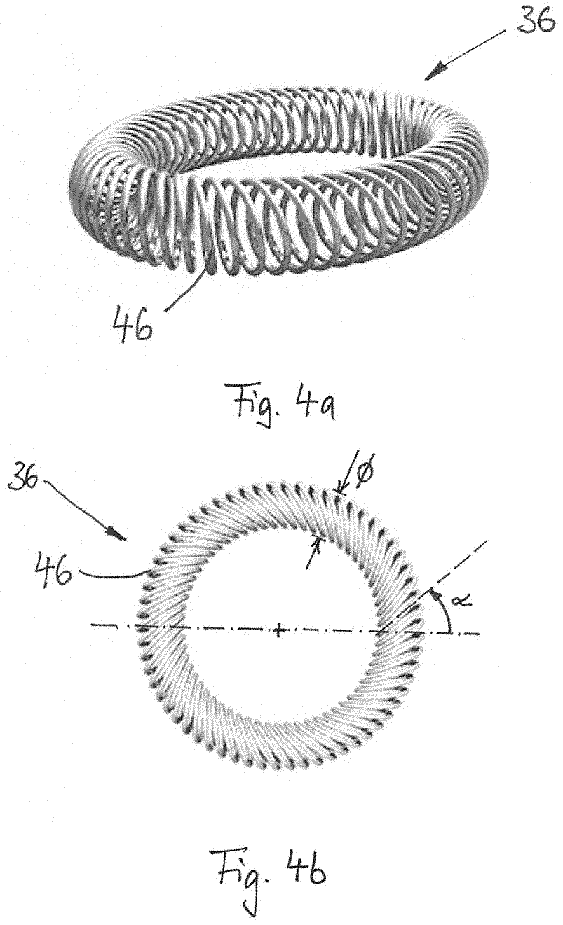

The spring element 36 is formed as a diametric spring, as shown in greater detail in FIGS. 4a and 4b. It is therefore an annular spring, which has been formed by joining, preferably welding, the ends of a spiral spring. In this case, the windings 46 are not parallel to the direction of the cross section of the spring, but are arranged so as to be inclined in a direction in a defined manner. The angle of inclination a, which measured relative to the radius, is in the range of from 40° to 50°, by contrast with annular springs made of commonplace spiral springs, where this angle is 0°. The cross section Ø of the windings 46 is 5.1 mm.

Since the depth of the second depression 38 is thus greater than half the cross section Ø of the windings 46 of the spring element 36, the spring element 36 is retained securely in the second depression 38, which is formed as an annular groove.

Preferably, the diametric spring 36 has 50 to 100 windings made of a high-alloy spring steel X7CrNiA1177 or material no. 14568 according to DIN EN 10270-3 in a thickness of 0.4 mm. Other resilient materials can also be used instead of this special spring steel. In addition, an O-ring could also be used instead of the diametric spring 36.

By means of this particular inclination of the windings 46, the diametric spring 36 can only be compressed a very small amount in the axial direction but very easily in the radial direction, wherein the diametric spring 36 always wants to return to its initial shape due to its spring elasticity.

FIG. 3 shows a closed state of the closure 32 between the lower part 12 and the cover 14. In order to achieve this, the cover 14 has been placed onto the lower part 12 in the closing direction S such that the actuation grip 24 can slide downwards on the hub 18. Over the course of this downward movement, the second chamfer 42 is brought into contact with the spring element 36, as a result of which both axial and radial forces are exerted on the spring element 36. The spring element 36 withstands the axial forces as far as possible and likewise converts these forces into radial forces which together cause the windings 46 to be radially pivoted, as a result of which the radial proportion of the cross section Ø decreases.

As a result, the raised portion 48, which is situated between the second chamfer 42 and the first chamfer 40, can slide past the spring element 36, as a result of which the spring element 36 penetrates into the first depression 34. As a result, the tension on the spring element 36 can be relieved again and in the process comes into contact with the first chamfer 40, by means of which, in conjunction with the tension on the spring element 36 being relieved, the cover 14 is automatically pulled onto the lower part 12 in the closing direction S until the spring element 36 comes into contact with the third chamfer 44 and said spring element 36 is centered in the first depression 34.

Since the first depression 34 is symmetrical and is situated precisely opposite the second depression 38 when the cover 14 is closed, the closure 32 is not exposed to any axial forces when the cover 11 is closed.

It could, however, also be provided that the first chamfer 40 extends with a greater inclination than the third chamfer 44, which thus extends more perpendicularly to the rotational axis D, as a result of which the spring element 36 exerts a greater force on the first chamfer 40 and therefore the cover 14 is preloaded against the lower part 12 in the closing direction S.

In addition, the position of the first depression 34 relative to the second depression 38 could also be changed when the cover 14 is closed such that the first depression 34 is arranged so as to be offset from the second depression 38 in the detaching direction. As a result, a force is also exerted on the cover 14 by the spring element 36.

At the same time, the seals 28, 30 are closed, meaning that the sample space 26 is sealed. Given that the closure 32 is situated outside the sample space 26 in relation to the seals 28, 30, the quality of the sealing of the sample space 26 is only dependent on the seals 28, 30 that are used. If annular rubber seals which come into contact with pressing surfaces are used here, aerosol-tight sealing of the sample space 26 from the surrounded portions can even be achieved.

In this context, it is preferably provided that the cover 14 can be moved slightly beyond the centered position of the spring element 36 in the first depression 34 in the direction of the lower part 12 in the closing direction S.

In order to detach the closure 32 again, the user simply needs to be lift the cover 14 from the lower part 12 in the detaching direction L by means of the actuation grip 24, which they can do by gripping and pulling up the actuation grip 24 with their index and middle fingers while generating counter-pressure on the supporting grip 22 with their thumb. In so doing, the actuation grip 24 slides upwards on the hub 18. Over the course of this upward movement, the spring element 36 is brought into increasing contact with the first chamfer 40, as a result of which both axial and radial forces are exerted on the spring element 36. The spring element 36 withstands the axial forces as far as possible and likewise converts these forces into radial forces which together cause the windings 46 to be radially pivoted, as a result of which the radial proportion of the cross section Ø decreases.

As a result, the raised portion 48 can slide past the spring element 36, as a result of which the spring element 36 is brought out of engagement with the first depression 34 and the cover 14 can be completely removed from the lower part 12.

It is clear therefrom that this is proper single-handed operation, because just one hand is needed to place the cover 14 onto the lower part 12 and close the closure 32 and to detach the closure 32 and remove the cover 14 from the lower part 12.

In addition, the closure 32 only has three elements, whereas the closure in EP 2 024 097 A1 has more than 10 elements, for example. In this case, the closure 32 is easy to maintain, since only the diametric spring 36 needs to be replaced to do this. In addition, the closure 32 is easy to produce, since the first depression 34 and the second depression 38 can be produced by turning, and no milling is required.

The closure 32 is very easily accessible and is particularly secure, since, due to the centrifugal forces acting during centrifuging, no axial forces act on the closure 32, but only radial forces, which brace the diametric spring 36 further against the first depression 34.

The strength of the closure 32 can be influenced in various ways and therefore can be adjusted in a targeted manner, wherein the following factors have an influence, inter alia:
the depth of the first depression 34, because the force of the closure increases the more the diametric spring 36 is compressed by first depression 34,
the spring force of the diametric spring 36, which is determined by the wire thickness, the number of windings, the wire material, and the geometry of the diametric spring 36, in particular the winding angle, and
the angle of the first chamfer 40.

Even though a diametric spring 36 has been described above as the spring element, it is clear that other spring elements can also be used, however. For example, they could be steel balls, which are each preloaded against a spring and engage in the first depression 34. This may be a number of evenly spaced steel balls. A rubber-elastic O-ring could also be used instead of the diametric spring 36. In addition, individual diametric-spring portions could be used rather than one continuous diametric spring 36, wherein these portions are then mounted in second depression portions that are accordingly arranged in portions. In addition, instead of spring-loaded balls, leaf springs having accordingly formed rounded portions or projections could also be used which engage in the first depression 34.

With the supporting grip 22, the entire centrifuge rotor 10 can be very simply and securely supported, even when the closure 32 is closed, because the actuation grip 24 can be pushed downwards in the closing direction S by the fingers surrounded portion the supporting grip 22.

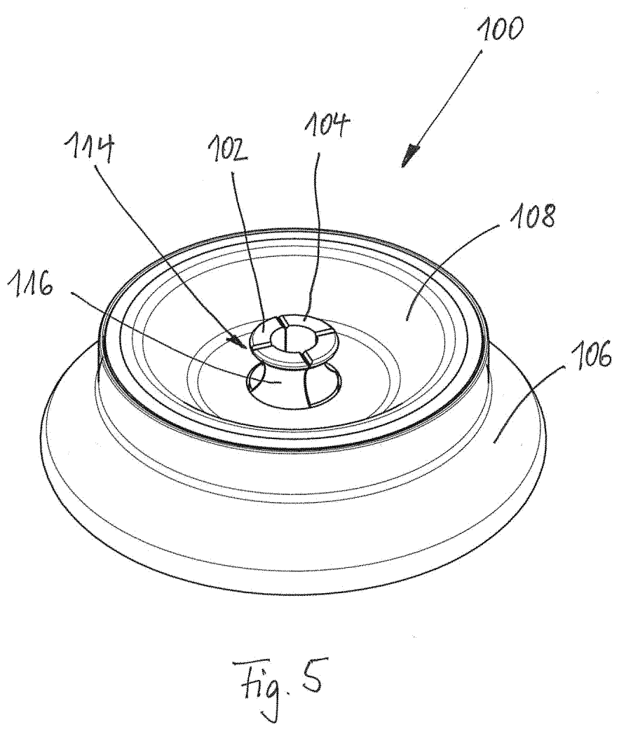

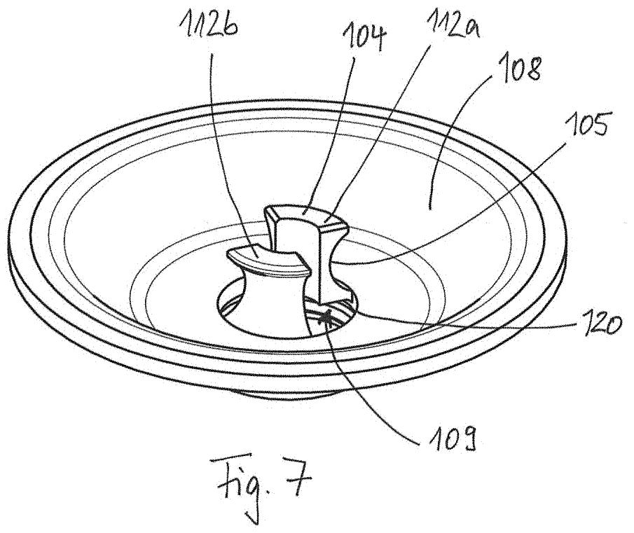

FIGS. 5 to 7 are various views of a second preferred embodiment of the centrifuge rotor 100. This centrifuge rotor 100 only differs in relation to the configuration of the supporting grip 102 and the actuation grip 104, while the remainder of the configuration of the lower part 106 and the cover 108 is identical, in particular in relation to the closure 109, and therefore this will not be explained again.

It is clear that, by contrast with the centrifuge rotor 10, the actuation grip 104 and the supporting grip 102 are designed here such that they complement one another to form a single element 102, 104 when the cover 108 is closed on the lower part 106.

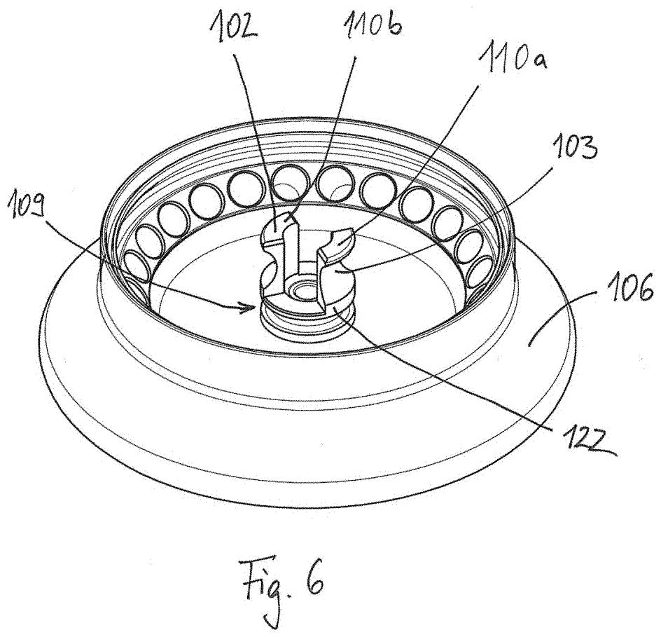

More precisely, according to FIG. 6, the supporting grip 102 is designed to comprise two opposing supporting grip elements 110a, 110b and respective undercuts 103 for gripping the supporting grip 102, and the actuation grip 104 is designed to comprise two opposing actuation grip elements 112a, 112b and respective undercuts 105 for gripping the actuation grip 104, which all, when the cover 108 is closed on the lower part 106, interlock with one another such that they fit together, wherein their contours are coordinated such that they complement one another in a rotationally symmetrical manner to form a single grip 114 comprising a single undercut 116. In this case, the actuation grip elements 112a, 112b project radially inwards relative to an opening 120, wherein this opening 120 is adapted to receive the hub 122 of the lower part 106 such that it fits therein.

Overall, this results in a larger grip 114, which may have a greater diameter than in the centrifuge rotor 10, since the supporting grip 102 no longer has to have a smaller diameter than the actuation grip 104. The centrifuge rotor 100 can therefore be handled, i.e. transported as well as opened and closed, more easily and comfortably.

One drawback of this configuration is that the cover 108 can then no longer be freely positioned on the lower part 106, but only with an angular orientation of 90° between the supporting grip 102 and the actuation grip 104. In order to prevent the user from accidentally only gripping the actuation grip 104 during support and not also at least gripping the supporting grip 102, it is preferably provided that the supporting grip 102 is the same color, for example black, as the rest of the lower part 106, while the actuation grip 104 is the same color, for example red, as the rest of the cover 108.

Even if, in the embodiments described, the spring element 36 is arranged in a second depression 38 in the hub 18 that is designed as an annular groove and the spring element 36 engages in a first depression 34 which is arranged on the cover 14, it is nevertheless clear that a reverse configuration can also be selected in which the spring element is arranged on the cover and engages in a first depression arranged on the hub.

In the embodiments shown, this could be implemented simply by it not being the annular groove 38 in the hub 18 that extends over greater than half of the cross section Ø of the windings 46 of the spring element 36, but rather the annular groove 34 in the cover. As a result, the spring element 36 would remain in the annular groove 34 in the cover and the annular groove 38 in the hub 18 would form the first depression, in which the spring element 346 engages during the closure process. To do this, the cross sections of the annular groove 34 and the annular groove 38 could simply be swapped.

It has become clear from the information set out that the present disclosure provides a centrifuge rotor 10, 100 in which the closure between the lower part of the centrifuge rotor 10, 100 and the cover 14, 108 has been improved such that proper single-handed operation is made possible. In particular, the closure can be closed and detached again using just one hand. This means that the closure has a simpler structure and can also be produced more cost-effectively.

Unless otherwise stated, all the features of the present disclosure can be freely combined with one another. Unless otherwise stated, the features described in the description of the figures can also be freely combined with the remaining features as features of the disclosure. Claimed features of the apparatus can also be reworded into method features as part of a method and method features can also be reworded into apparatus features as part of the apparatus.

### LIST OF REFERENCE SIGNS

10 first preferred configuration of the centrifuge rotor
12 lower part
14 cover
16 holes or compartments for receiving sample vessels
18 hub
20 hole in hub 18
22 supporting grip
23 undercut for gripping the supporting grip 22
24 actuation grip
25 undercut for gripping the actuation grip 24
26 sample space
28 outer seal between lower part 12 and cover 14
30 inner seal between lower part 12 and cover 14
32 closure between lower part 12 and cover 14
34 first depression in the cover
36 spring element, annular spring, diametric spring
38 second depression in the hub 18
40 first chamfer, detaching aid
42 second chamfer, closing aid
44 third chamfer
46 windings of the spring element 36
48 raised portion between the second chamfer 42 and the first chamfer 40
100 second preferred embodiment of the centrifuge rotor
102 supporting grip
103 undercut for gripping the supporting grip 102
104 actuation grip
105 undercut for gripping the actuation grip 104
106 lower part
108 cover
109 closure
110a, 110b supporting grip elements
112a, 112b actuation grip elements
114 single grip
116 undercut of the single grip 114
120 opening in cover 108
122 hub of the lower part 106
α angle of inclination of the windings 46
Ø cross section of the windings 46
D rotational axis D
L detaching direction
S closing direction

1.-15. (canceled)

16. A centrifuge rotor (10; 100), comprising:
a lower part (12; 106); and
a cover (14; 108),
wherein the centrifuge rotor (10; 100) has a rotational axis (D),
wherein the cover (14; 108) can be placed onto the lower part (12; 106) along the rotational axis (D) in a closing direction (S) and can be removed along the rotational axis (D) in a detaching direction (L),
wherein, when the cover (14; 108) is closed, there is a closure (32; 109) between the lower part (12; 106) and the cover (14; 108),
wherein at least one element selected from the group consisting of the lower part (12; 106) and the cover (14; 108) comprises at least one first depression (34), in which, when the cover (14; 108) is closed, at least one spring element (36) engages, which is arranged on another element selected from the group consisting of the cover (14; 108) and the lower part (12; 106).

17. The centrifuge rotor (10; 100) according to claim 16, wherein the first depression (34) and the spring element (36) are adapted to provide a clip connection.

18. The centrifuge rotor (10; 100) according to claim 16,
wherein the first depression (34) is designed to open perpendicularly to the rotational axis (D), and/or
wherein the first depression is designed as a first annular groove (34).

19. The centrifuge rotor (10; 100) according to claim 16,
wherein the first depression (34) comprises a detaching aid, which is designed as a first chamfer (40) or rounded portion, and by which the spring element (36) is brought out of engagement with the first depression (34) when the cover (14; 108) is removed from the lower part (12; 106).

20. The centrifuge rotor (10; 100) according to claim 19,
wherein in relation to the closing direction (S), a closing aid is arranged between the first depression (34) and the lower part (12; 106), which is designed as a second chamfer (42) or rounded portion, and by which the spring element (36) is brought into engagement with the first depression (34) when the cover (14; 108) is placed onto the lower part (12; 106).

21. The centrifuge rotor (10; 100) according to claim 20,
wherein the first depression (34) comprises a third chamfer (44) or rounded portion in relation to the detaching direction (L) on the side facing away from the lower part (12; 106).

22. The centrifuge rotor (10; 100) according to claim 21,
wherein the first chamfer (40) and/or the second chamfer (42) and/or the third (44) chamfer have an angle in the range of from 30° to 80° relative to the rotational axis (D).

23. The centrifuge rotor (10; 100) according to claim 16,
wherein the spring element is an annular diametric spring (36).

24. The centrifuge rotor (10; 100) according to claim 16,
wherein the spring element (36) is arranged in a second depression (38) which is designed as a second annular groove (38), and
wherein the second annular groove (38) comprises lateral boundaries that extend perpendicularly relative to the rotational axis (D).

25. The centrifuge rotor (10; 100) according to claim 24,
wherein the spring element (36) has a cross section (0) relative to its windings (46) and, when the cover (14; 108) is open, at least a quarter of this cross section (0) is positioned in the second depression (38).

26. The centrifuge rotor (10; 100) according to claim 16,
wherein the cover (14; 108) and/or the lower part (12; 106) has an undercut (23; 103, 105) which acts as a grip (22; 102, 114) for supporting the centrifuge rotor (10; 100), and
wherein the undercut (23; 103, 105) projects relative to the cover (14; 108).

27. The centrifuge rotor (10; 100) according to claim 16,
wherein a part (22; 102, 110a, 110b) of the lower part (12; 106) reaches through the cover (14; 108) when closed and acts as a support aid (22; 102) for the centrifuge rotor (10; 100), and
wherein this part has a contrasting color from the cover (14; 108).

28. The centrifuge rotor (100) according to claim 27,
wherein the part (110a, 110b) of the lower part (106) is designed as at least two supporting grip elements (110a, 110b) that are arranged so as to be spaced apart and/or opposite one another relative to the rotational axis (D) and complement one another together with corresponding elements (112a, 112b) of the cover (108) to form a continuous grip (114).

29. The centrifuge rotor (10; 100) according to claim 16,
wherein the cover (14; 108) is designed without movable parts, in one piece, in relation to the closure (32; 109).

30. The centrifuge rotor (10; 100) according to claim 16,
wherein there is a preferably aerosol-tight seal (28, 30) between the cover (14; 108) and the lower part (12; 106), such that the closure (32; 109) is arranged outside a sample space (26) formed between the cover (14; 108) and the lower part (12; 106) in relation to the seal (28, 30).
